(19) United States
(12) Patent Application Publication
(10) Pub. No.: US 2011/0282950 A1
(43) Pub. Date: Nov. 17, 2011

(54) REVERSE MESSAGE CLASSIFICATION

(76) Inventor: Kfir Luzzatto, Omer (IL)

(21) Appl. No.: 13/102,172

(22) Filed: May 6, 2011

Related U.S. Application Data
(60) Provisional application No. 61/333,761, filed on May 12, 2010.

(51) Int. Cl. G06F 15/16

(52) U.S. Cl. 709/206

(57) ABSTRACT

In an electronic message classification method an incoming message is preliminary classified according to its importance and information concerning that classification is provided to the Sender, thereby giving the Sender an option to overrule said preliminary classification.

### FIELD OF THE INVENTION

The present invention relates to the classification of electronic messages. More particularly, the invention relates to a method and system for reversing the burden of message classification.

### BACKGROUND OF THE INVENTION

Electronic messages have become an important part of everyday's life for the vast majority of the population. Such electronic messages are of various types and currently include mostly e-mail and SMS, although additional types of electronic messaging are emerging, for instance those embedded in social networks. Undeniably, electronic messaging is of great value and, in fact, has become indispensable, but a severe problem threatens to undermine its usefulness. The problem arises from the rapidly growing number of people who use electronic messaging in their everyday's life and work, the rapidly expanding abilities of equipment, such as cellular phones that exist in very large numbers, to generate electronic messages easily and conveniently. As a result, the number of messages received by each individual grows steadily and, for some users, has become unmanageable.

The art has provided a partial solution to this problem by developing efficient spam filters, which effectively remove a substantial proportion of messages sent by spammers, which may or may not include malicious software. However, the art has so far failed to provide a solution for the ever-increasing problem, which may be termed “friendly spam”, i.e., messages sent by people known to the Recipient, which are addressed to him or her without any malicious intent, but which the Recipient has no interest in receiving and no need to read. In many corporate environments people reports daily waste of time in reviewing such friendly spam, to be able to classify it as such, which at times is said to require one working hour or more. This results not only in a waste of work time and in the resulting financial loss, but also in great frustration of the Recipient.

Unfortunately, however, the electronic message recipient is essentially a captive audience, since he cannot ignore electronic messages received because useless and undesired messages are mixed with important ones that must be reviewed and acted upon. In many cases important and useless messages are received from the same sender, often within short periods of time. A side problem arising from this situation is that some recipients may become less attentive and miss important messages.

It is an object of the present invention to provide a method and system that overcomes many disadvantages of existing electronic messaging systems and substantially helps to reduce the number of electronic messages that a recipient must actually read.

It is another object of the invention to provide a method and system by which friendly messages can be classified by the Recipient prior to reading them and without effort, while minimizing the risk of missing or losing important electronic messages

Other objects and advantages of the invention will become apparent as the description proceeds.

### SUMMARY OF THE INVENTION

The present invention relates to an electronic message classification method, wherein an incoming message is preliminarily classified at the Recipient's end according to its importance, and information concerning that classification is then provided to the Sender, thereby giving the Sender an opportunity to overrule said preliminary classification. According to an embodiment of the invention a message is sent to the Sender, said message comprising means for allowing the sender to ask for a change of the classification of the message at the Recipient's end.

In one embodiment of the invention the preliminary classification is performed at the Recipient's end automatically.

The electronic message can be of any type, for instance, it can be selected from e-mail messages, SMS and instant messages.

The invention also encompasses a system for classifying electronic messages received by a Recipient from a Sender, comprising software provided at the Recipient's end for effecting a preliminary classification according to preset rules, means to generate a response message containing classification information relative to a specific electronic message, and communication means for transmitting said response message to said Sender.

### BRIEF DESCRIPTION OF THE DRAWINGS

In the drawings:

FIG. 1 shows an illustrative set of folders used in an example of use of the invention;

FIG. 2 illustrates the procedure by which a reverse classification message (as explained hereinafter) is sent out according to one particular example of implementation of the invention; and

FIG. 3 is a further example of implementation of the process according to another embodiment of the invention.

### DETAILED DESCRIPTION OF THE INVENTION

Throughout the description to follow and examples provided herein reference will be made to e-mail as the exemplary electronic messaging system, it being understood that the invention is equally applicable, mutatis mutandis, to other electronic messaging systems, such as SMS, instant messaging, etc.

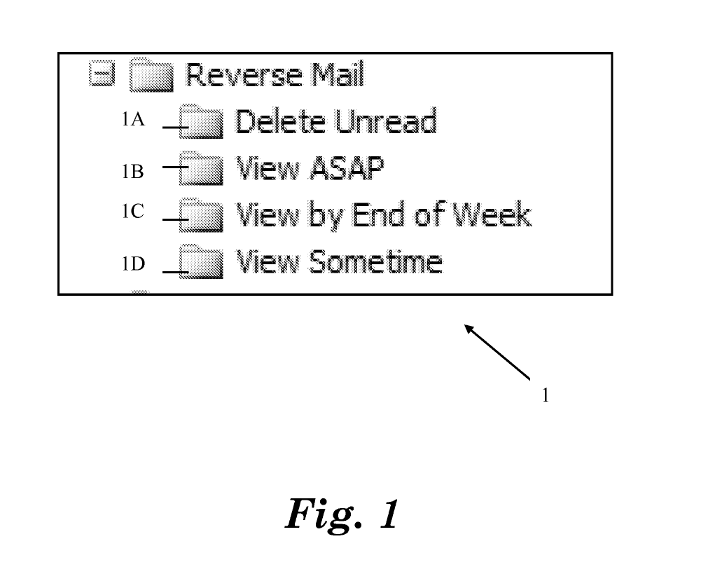

FIG. 1 shows a set of folders generally indicated by numeral 1 as may be generated by a user, for instance in Microsoft Outlook, for the purposes of the invention. The set of folders 1, identified as “Reverse Mail”, contains subfolders 1A through 1D, which have been created by the user and are intended to receive e-mail messages which, based on user-defined rules to be further discussed below, are classified as having different priorities. Messages routed to the “Delete Unread” folder 1A will never be read by the Recipient, those routed to folder 1B, “View ASAP”, will be viewed as soon as the Recipient can make time for them, after dealing with regular messages appearing in the main window of his inbox; messages routed to folder 1C, “View by End of Week”, would be the next to be read, while those routed to the “View Sometime” folder 1C will be looked at on some unspecified date. Of course, the structure shown in FIG. 1 is just an illustrative example and each user may adopt its own definitions and may generate different types and numbers of folders that obey different rules.

The Recipient may set different rules in a way similar to what already exists in Microsoft Outlook and other e-mail clients. For instance, the Recipient may decide that all messages received from a specified Sender will be routed to a specific folder, or the routing may be made on the basis of content, title, or by the combination of any number of attributes of the incoming message. It should be appreciated that this routing is not a classification of the incoming message and, therefore, the correctness of this routing is of low importance to the invention, as will be immediately appreciated by the description to follow. It is also important to understand that the Recipient bears no burden in the ultimate classification of the incoming messages and, therefore, he does not need to be concerned with the level of sophistication of his initial routing. This is an important element of the invention, which turns the method and system of the invention into a practically realizable one.

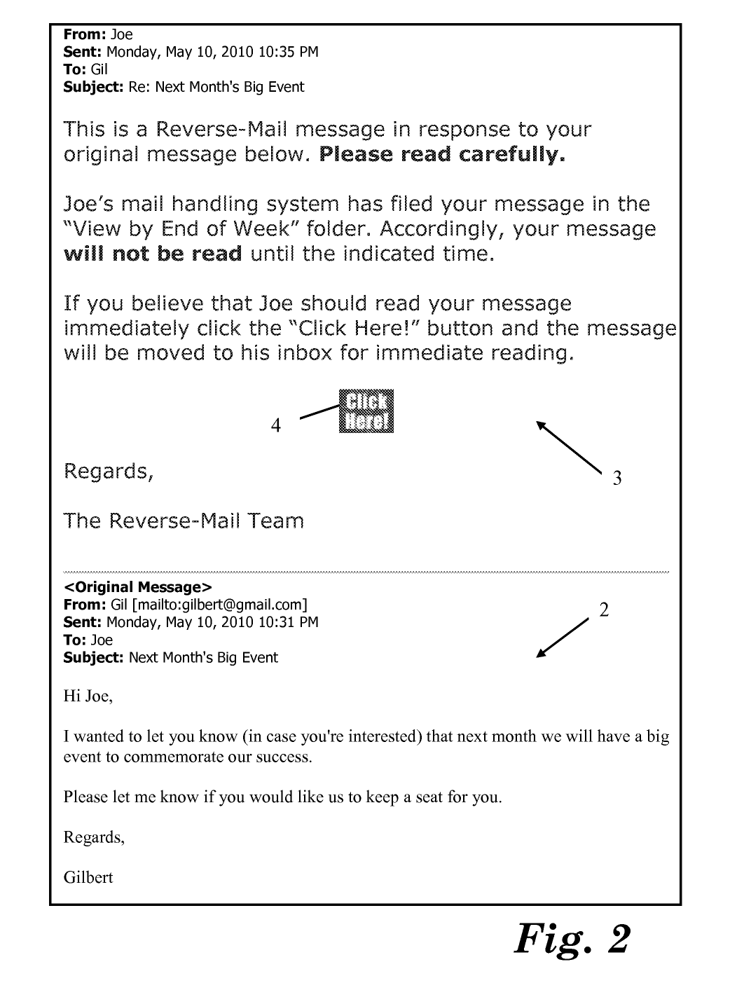

Looking now at FIG. 2, the process of the invention can be easily understood. This figure shows what happens to a message 2, sent to Joe (the Recipient) from Gil (the Sender). According to the rules that Joe has created, the message from Gil was routed to the “View by End of Week” folder 1C of FIG. 1. At this stage of the process neither Joe nor the system know whether the routing was made correctly. However, according to the method of the invention once the message is filed in that folder the system generates the message indicated by numeral 3 and shown in the upper portion of the figure. Gil therefore receives a message informing him or her that his message has been classified such that it will not be read until the end of the week. At this point—and this is a critical element of the invention—if Gil believes that his message should receive immediate attention he can click the button 4 provided in the message, which will forward this conversation, or its relevant portion, to the section of Joe's inbox, or a folder, where it will receive immediate attention. Alternatively, according to another embodiment of the invention Gil may simply reply to the message 3, without adding text or, if desired, with added text, and when such reply message (not shown) is received in Joe's inbox it will be routed to a specified location that receives immediate attention, as may be his regular inbox or a specific “Read Immediately” folder (not shown). Additional attention-calling measures can of course be provided, if desired, such as pop-ups or other audio or visual messages, so that Joe is alerted to the need to review this message without delay. The classification button 4 or other procedures by which the message is reclassified according to a request of the sender, can be implemented in various ways known to the men of the art, which may vary from one e-mail client to another and, therefore, is not discussed herein in detail for the sake of brevity. It is also possible to establish other rules, e.g., one that does not allow a sender to reclassify his email or certain types of email, thus essentially forcing his messages to be read at the time that the recipient has selected.

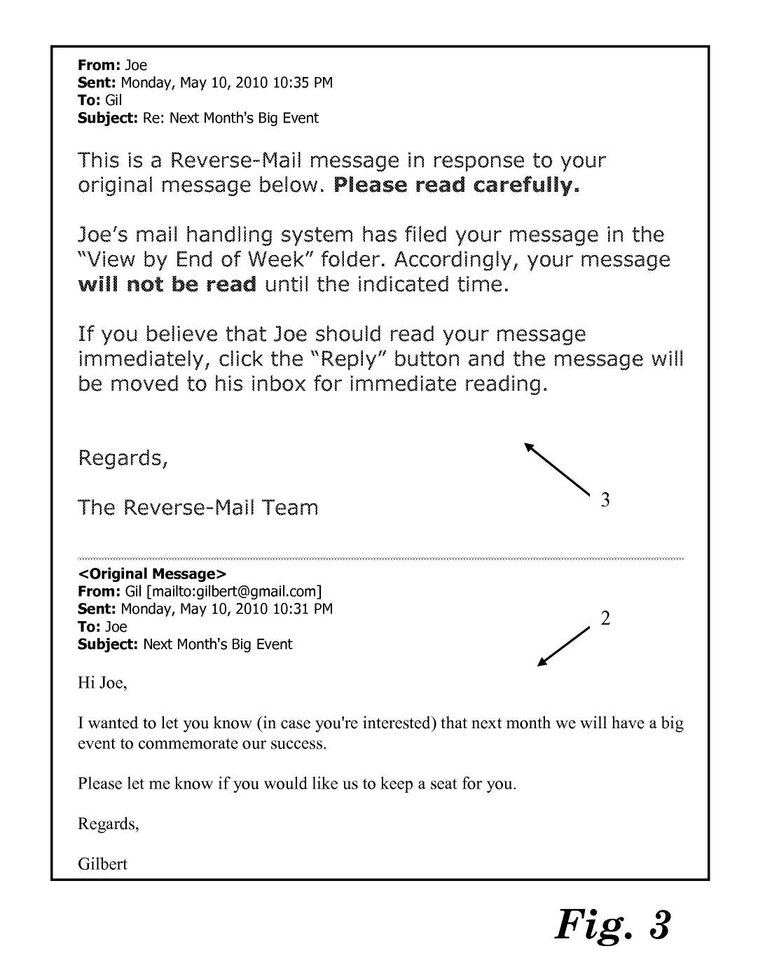

Alternatively, as discussed above and as illustrated in FIG. 3, the Sender may simply hit the “Reply” button of his e-mail software and return the message (2+3′ in FIG. 3) to the Recipient. The software agent coupled to the Recipient's e-mail client then recognizes the returning message 3′, either through its content or by any marker(s) that were provided in it before sending to the Sender, and either uses it to retrieve the original message 2 from the folder in which it was preliminary stored, or simply shows it to the Recipient in his inbox or in any other way, such as by pop-up. This option is particularly useful when a web mail program is used, from which it is less convenient to activate executable objects. According to this embodiment of the invention the Sender's e-mail client operates regularly without the need for any additional operation.

As it will be apparent to the skilled person, the invention can be implemented in many variants and the examples provided herein are intended to be an illustration and not to limit the scope of the invention in any way. For instance, in one embodiment of the invention overruling by the Sender does not automatically change the classification of the message but only provides a suggestion to the Recipient to do so. In another embodiment of the invention, when an attachment is present in the message sent by the Sender it is not included in the message sent back to the Sender, thus slimming and streamlining the load on the communication line. Many other examples and variants will be apparent to the man of the art.

The receipt of the message illustrated in FIGS. 2 and 3 accomplishes important results:

1. It places the burden of classifying the message on the Sender. The Sender knows the real importance of the message he has sent, oftentime thoughtlessly, and also receives an indication of the level of urgency that the Recipient attributes to it. Accordingly, the Sender is expected to be careful in classifying (or reclassifying) his message differently than done by the Recipient's system.

2. A Sender who indiscriminately disseminates unimportant messages to a number of people will have his practice backfire on him or her because the more unnecessary e-mails he sends, the more requests from Recipients he will receive, which in turn will take a toll of his time. Thus, for instance, distributing a single unimportant e-mail to five people equipped with the invention will result in five messages that the Sender will have to review and consider. It is therefore expected that the Sender will exercise greater care in the future and will be more thoughtful of the way in which he sends out “friendly spam”.

3. The Recipient will be able to establish a level of trust for the people who send him or her messages regularly, by considering whether requests by the Sender of immediate consideration of his messages are commensurate with their importance. This will assist the Recipient in refining sender-specific routing rules, either by “whitelisting” the Sender or by assigning a lower priority to messages received from him or her.

The invention can be implemented in a variety of ways well understood by the skilled person, both as client/server solutions and as standalone client solutions. In one embodiment of the invention a software element is provided to intercept a message before it reaches the inbox for the purpose of adding attributes to it, which may be useful in the initial routing (also referred to herein as “preliminary classification”). Such attributes can then be used by the e-mail client to route the message in a conventional way. Alternatively, the preliminary classification can be fully performed before the message reaches the inbox and the e-mail client only needs to route it to the appropriate folder according to preset rules. In this embodiment of the invention it may be convenient to generate the so-called “reverse-mail message” at the same stage, although of course many different processes can be implemented.

In an alternative embodiment of the invention the classification process is fully integrated in the e-mail client (or, if the electronic message is of a different type, such as SMS, in the SMS or other messaging client).

The above description has been provided for the purpose of illustration and is not intended to limit the invention in any way. Many different processes, classification modules and schemes can be provided by skilled persons, without exceeding the scope of the invention.

1. An electronic message classification method, wherein an incoming message is preliminary classified at the Recipient's end according to its importance, and information concerning that classification is then provided to the Sender, thereby giving the Sender an opportunity to overrule said preliminary classification.

2. A method according to claim 1, wherein a message is sent to the Sender, said message comprising means for changing the classification of the message at the Recipient's end.

3. A method according to claim 1, wherein the preliminary classification is performed at the Recipient's end automatically.

4. A method according to claim 1, wherein the electronic message is selected from e-mail messages, SMS and instant messages.

5. A method according to claim 2, wherein the message sent to the Sender is enriched with visible or hidden information.

6. A method according to claim 2, wherein the means for changing the classification of the message at the Recipient's end comprise instructions to the Sender to perform an activity.

7. A method according to claim 2, wherein when an attachment is present in the message sent by the Sender it is not included in the message sent back to the Sender.

8. A method according to claim 1, wherein overruling by the Sender does not automatically change the classification of the message but only provides a suggestion to the Recipient to do so.

9. A system for classifying electronic messages received by a Recipient from a Sender, comprising software provided at the Recipient's end for effecting a preliminary classification according to preset rules, means to generate a response message containing classification information relative to a specific electronic message, and communication means for transmitting said response message to said Sender.

10. An electronic messaging client, comprising software suitable to carry out the method of claim 1.

11. The electronic messaging client of claim 9, which is selected from an e-mail client, an SMS software or an Instant Messenger.
